(19) United States
(12) Patent Application Publication
(10) Pub. No.: US 2010/0270801 A1
(43) Pub. Date: Oct. 28, 2010

(54) ELECTRICITY STORAGE AND RECOVERY SYSTEM

(76) Inventor: KUO-SHEN LIU, Taipei (TW)

Correspondence Address: LEONG C LEI, PMB # 1008, 1867 YGNACIO VALLEY ROAD, WALNUT CREEK, CA, 94598, US

(21) Appl. No.: 12/430,910

(22) Filed: Apr. 28, 2009

(51) Int. Cl. H02K 7/18; F15B 1/027

(52) U.S. Cl. 290/52

(57) ABSTRACT

The electricity storage and recovery system. At first, injects high-pressure gas in a high-pressure tank and then, the normal-pressure fluid from a normal-pressure tank is pumped into the high-pressure tank by a motor-driven pump so that the electrical energy is converted to high-pressure potential energy of the fluid stored inside the high-pressure tank. To recover the potential energy back to electrical energy, the high-pressure fluid flows from the bottom of the high-pressure tank to the normal-pressure tank through a turbine. The turbine in turn drives a generator to produce electricity. The pump and the turbine are of a same device running in opposite directions. The motor and the generator are also of a same device running in opposite directions.

### (a) TECHNICAL FIELD OF THE INVENTION

The present invention generally relates to devices for electricity storage and recovery system, and more particularly to store electricity in off-peak hour then recover it during the period of peak demand.

### (b) DESCRIPTION OF THE PRIOR ART

Electricity consumption has high peak periods and off peak periods and therefore storing electrical energy during off peak periods and retrieving the stored energy during high peak periods is a common practice. Currently, there are two major approaches for storing large-volume electrical energy. One is compressed air energy storage (CAES) and the other one is pumped hydro storage. The former has high energy density but low conversion efficiency. Usually, to convert the stored energy back to electrical energy requires heating using fuel. For the latter, even though the recovery efficiency could reach 80%, the construction of a huge dam is required. There are limited construction sites and huge cost is involved, in addition to the profound impact to the ecosystem. As such, a satisfactory approach for electricity storage and recovery system is yet to be found.

### SUMMARY OF THE INVENTION

A major purpose of the present invention therefore is to provide a low-cost and simple electrical energy storage and recovery system that is not limited to specific construction sites and that the electricity storage and recovery is more economical.

The electricity storage and recovery system, at first injects high-pressure gas in a high-pressure tank and then, the normal-pressure fluid (such as water, salty water, or oil) from a normal-pressure tank is pumped into the high-pressure tank by a motor-driven pump so that electrical energy is converted to high-pressure potential energy of the fluid stored inside the high-pressure tank. To convert the potential energy back to electrical energy, the high-pressure fluid flows from the bottom of the high-pressure tank to the normal-pressure tank through a turbine. The turbine in turn drives a generator to produce electrical energy. The pump and the turbine are of a same device running in opposite directions. The motor and the generator are also of a same device running in opposite directions.

According to the present invention, if the pressure inside the high-pressure tank is 300 bars, the stored potential energy is equivalent to that of a 3,000-meter-high dam. The present invention therefore has a significantly higher energy density than the conventional hydroelectric power plant.

According to the present invention, when the normal-pressure fluid is pumped into the high-pressure tank, the temperature of the high-pressure gas would rise as it is compressed. Therefore, in an embodiment of the present invention, the normal-pressure fluid is sprayed from the top of the high-pressure tank by a sprayer so as to reduce the temperature of the high-temperature gas and also to store the heat energy in the fluid. If such heat exchange is not enough, the high-pressure fluid is drawn from the bottom of the high-pressure tank to the sprayer through an additional pump so as to reduce the gas/fluid temperature difference as much as possible.

According to the present invention, as the pressure inside the high-pressure tank rises, an automatic valve is provided to throttle the flow of the normal-pressure fluid into the high-pressure tank. As such, the pump could be operated under a constant power. On the other hand, when the high-pressure fluid flows out of the high-pressure tank and the pressure of the high-pressure tank drops, the automatic valve gradually enlarges its aperture to allow more fluid to flow through so that the generator could deliver a constant output power.

According to the present invention, as the high-pressure tank needs to withstand a high pressure, the high-pressure tank could be built underground so that a less strong and thereby less expensive material could be used for the construction of the high-pressure tank. The high-pressure tank could be further wrapped by heat insulation material to reduce energy loss.

According to the present invention, when the high-pressure fluid flows out of the high-pressure tank and the high-pressure gas cools down as it expands, the aforementioned additional pump draws the high-pressure fluid from the bottom of the high-pressure tank to the sprayer for additional heat exchange so as to reduce the gas/fluid temperature difference as much as possible. This is also the means to convert the heat energy of the fluid to gas pressure, and then into to electrical energy.

According to the present invention, if the required pressure is too high to be provided by the off-the-shelf pump/turbine, two or more pumps/turbines could be cascaded in stages to provide the required pressure.

According to the present invention, the electrical energy storage and conversion device could omit the means of heat exchange for even lower construction cost and simply employs a thermal baffle inside the high-pressure tank to separate the high-pressure gas and fluid. This could reduce the solubility of the high-pressure gas in the high-pressure fluid.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing an electricity storage and recovery system according to an embodiment of the present invention.

FIG. 2 is schematic diagram showing an electricity storage and recovery system according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

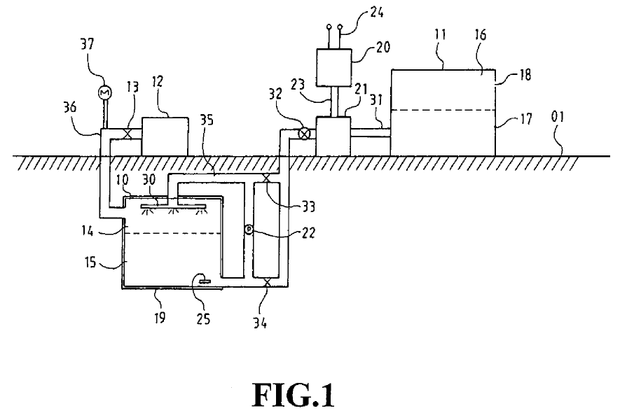

As shown in FIG. 1, an electrical electricity storage and recovery system according to an embodiment of the present invention mainly contains a high-pressure tank 10 where high-pressure gas 14 and high-pressure fluid 15 (i.e., working fluid) such as water, saline water, or oil, are stored inside, and an ordinary-pressure tank 11 where normal-pressure gas 16 and normal-pressure fluid 17 identical to the high-pressure fluid 15 are stored inside. If air is used as the normal-pressure gas 16, the tank 11 has a ventilation opening 18 so that the normal-pressure gas 16 is maintained under a normal pressure (i.e., 1 bar).

When the electricity storage and recovery system is engaged, initially, a compressor 12 injects high-pressure gas 14 into the high-pressure tank 10 through a gas pipe 36 having a pressure gauge 37. Through the pressure gauge 37, the compressor 12 is automatically stopped and shut the valve 13 when the pressure inside tank 10 has reached a value and, as some high-pressure gas 14 would dissolve in the high-pressure fluid 15, the compressor 12 is automatically started and open the valve 13 when the pressure inside tank 10 is below a value to supplement the high-pressure gas 14. The storage of electricity can be done, when the pressure inside the high-pressure tank 10 has reached a certain level, a motor/generator 20 is turned on where electricity is drawn from conduction wires 24 and the motor/generator 20 rotates a shaft 23 which in turn drives a pump/turbine 21. The pump/turbine 21 draws normal-pressure fluid 17 out of the normal-pressure tank 11 through a first fluid pipe 31. The normal-pressure fluid 17 is then pushed to a sprayer 30 inside the high-pressure tank 10 sequentially via a first valve 32, a second value 33, and a second fluid pipe 35 (please note that a third valve 34 is closed in the mean time). The normal-pressure fluid 17 is then sprayed by the sprayer 30 to conduct heat exchange with the compressed high-pressure gas 14 and then to deposit at the bottom of the high-pressure tank 10 as the high-pressure fluid 15.

The high-pressure tank 10 could be buried below the ground 01 to save material cost. Alternatively, the high-pressure tank 10 could be wrapped by a heat insulation material 19 to reduce energy loss.

The first valve 32 would be automatically adjusted to gradually reduce its aperture when the pressure inside the high-pressure tank 10 rises so that the electricity consumed by motor/generator 20 is maintained at a constant. To recover electricity, the third valve 34 on a third fluid pipe that runs from the bottom of the high-pressure tank 10 to the second fluid pipe 35 between the first and second valves 32 and 33 is opened and the second valve 33 is closed. The high-pressure fluid 15 would drive the pump/turbine 21 and thereby the shaft 23 to run in a reversed direction. The shaft 23 then drives the motor/generator 20 to produce and output electricity to the wires 24. The high-pressure fluid 15 is then stored in the normal-pressure tank 11 and becomes the normal-pressure fluid 17.

A branch pipe is provided to connect the second and third fluid pipes in front of (i.e., closer to) the high-pressure tank 11. A pump 22 is provided on the branch pipe. When the sprayed normal-pressure fluid 17 is not enough, the pump 22 is automatically opened to supplement the heat exchange and to reduce the gas/fluid temperature difference as much as possible. On the other hand, when the high-pressure fluid 15 flows to the low-pressure tank 11, the pump 22 is also opened automatically to supplement the fluid sprayed so that the high-pressure gas 14 does not cool down due to its expansion. Additionally, a supersonic vibrator 25 is provided near the bottom inside the high-pressure tank 10. When the high-pressure fluid 15 flows to the low-pressure tank 11, the supersonic vibrator 25 which is submerged in the high-pressure fluid 15 is turned on to drive out the gas dissolved in the high-pressure fluid 15.

As high-pressure fluid 15 flows to the normal-pressure tank 11 and the pressure inside the high-pressure tank 10 drops, the first valve 32 gradually opens its aperture so as to maintain a constant output by the motor/generator 20.

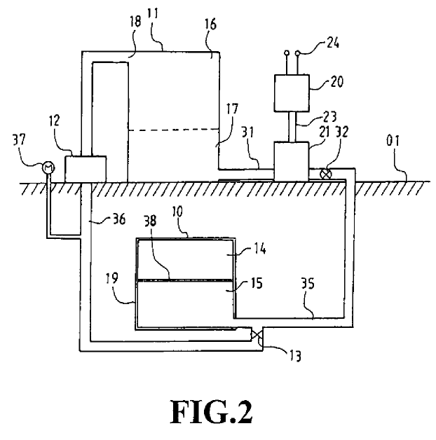

FIG. 2 shows another embodiment of the present invention where the electricity storage and recovery system is simplified and heat exchange is not employed. As illustrated, a thermal baffle 38 is provided inside the high-pressure tank 10. The thermal baffle 38 is lighter than the high-pressure fluid 15 and therefore it float on the surface of the high-pressure fluid 15. The purpose of the provisioning of the thermal baffle 38 is, on one hand, for heat insulation, and, on the other hand, to reduce the solubility of the high-pressure gas 14 in the high-pressure fluid 15. In the present embodiment, the first valve 32 is completely closed when the electrical energy storage and conversion device is shut down. In addition, if air is not used as the high-pressure gas 14 and the dissolved high-pressure gas 14 released in normal-pressure tank 11 is recycled by the compressor 12 through the ventilation opening 18.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An electricity storage and recovery system, comprising:
a high-pressure tank;
a normal-pressure tank containing a fluid of a normal pressure;
a compressor injecting a gas of high pressure into said high-pressure tank;
an electrical motor
a pump driven by said motor pumping said fluid from said normal-pressure tank into said high-pressure tank so as to store electrical energy into high-pressure potential energy of said fluid in said high-pressure tank;
a turbine driven by said fluid when said fluid flows from said high-pressure tank to said normal-pressure tank; and
a generator driven by said turbine to produce electricity.

2. The electricity storage and recovery system according to claim 1, wherein said fluid is one of water, saline water, or oil.

3. The electricity storage and recovery system according to claim 1, wherein, if said gas is not air, gas dissolved in said fluid and released in said normal-pressure tank is recycled by said compressor.

4. The electricity storage and recovery system according to claim 1, wherein said pump and said turbine are of a same device running in opposite directions; and said electrical motor and said generator are of a same device running in opposite directions.

5. The electricity storage and recovery system according to claim 1, wherein a gas valve is provided on a gas pipe between said compressor and said high-pressure tank; when the pressure of said high-pressure tank reaches a value, said gas valve closes said gas pipe to prevent gas from being compressed into said high-pressure tank; when the pressure of said high-pressure tank drops, said gas valve opens said gas pipe so that more gas is compressed into said high-pressure tank; and a supersonic vibrator is provided inside said high-pressure tank to release dissolved gas in said fluid.

6. The electricity storage and recovery system according to claim 1, wherein, when said fluid flows into or out of said high-pressure tank, heat exchange happens between said fluid and compressed gas inside said high-pressure tank.

7. The electricity storage and recovery system according to claim 6, wherein said fluid is sprayed into said high-pressure tank by a sprayer on a top side inside said high-pressure tank to facilitate heat exchange; and a second pump is provided to draw said fluid from the bottom of said high-pressure tank to said sprayer for heat exchange.

8. The electricity storage and recovery system according to claim 6, wherein two fluid pipes connecting the top and bottom of said high-pressure tank for said fluid's flowing in and out of said high-pressure tank, respectively; each fluid pipe has a fluid valve to control the flowing of said fluid; and said fluid pipes merge into a single common pipe.

9. The electricity storage and recovery system according to claim 8, wherein an automatic valve is provided on said common pipe; said automatic valve gradually reduces its opening as said fluid flows into said high-pressure tank; and said automatic valve gradually enlarges its opening as said fluid flows out of said high-pressure tank, so that said motor and said generator are maintained at a substantially constant power.

10. The electricity storage and recovery system according to claim 1, wherein said high-pressure tank is buried underground for reduced material cost.

11. The electricity storage and recovery system according to claim 1, wherein said high-pressure tank is wrapped by a heat insulation material to reduce energy loss.

12. The electricity storage and recovery system according to claim 1, wherein a thermal baffle is provided inside said high-pressure tank floating on the surface of said fluid for heat insulation and for reducing said gas' solubility in said fluid.

13. The electricity storage and recovery system according to claim 1, wherein said gas and said fluid enter said high-pressure tank through a same pipe. Also the gas inlet and fluid inlet to the high pressure tank also can be same one.
